(19) United States
(12) Patent Application Publication
(10) Pub. No.: US 2010/0180562 A1
(43) Pub. Date: Jul. 22, 2010

(54) PROCESS FOR PREPARATION OF SILICON CARBIDE SEGMENT FOR HONEYCOMB CERAMIC FILTER

(76) Inventors: Young Min Kong, Daejeon (KR); Dae Gon Han, Daejeon (KR)

Correspondence Address: HOLME ROBERTS & OWEN LLP, 1700 LINCOLN STREET, SUITE 4100, DENVER, CO, 80203, US

(21) Appl. No.: 12/597,721

(22) PCT Filed: Oct. 27, 2007
(86) PCT No.: PCT/KR07/05336

§ 371 Date: Nov. 23, 2009

(30) Foreign Application Priority Data
Apr. 26, 2007 (KR) 10-2007-0040699

(51) Int. Cl. B01D 39/20; C04B 35/64; B05D 3/00

(52) U.S. Cl. 55/523; 427/190; 427/193

(57) ABSTRACT

Disclosed herein is a method for preparing a silicon carbide segment for a honeycomb ceramic filter as a diesel particulate filter (DPF) by conducting drying, perforating, plugging, and sintering processes for an extruded body cut into a segment having a predetermined size, wherein a sealant, which will melt and adhere to corners of cells in the sintering process, to seal the cell corners, is applied to partition walls of the segment at opposite ends of the segment in the plugging process.

### FIELD OF THE INVENTION

The present invention relates to a method for preparing a silicon carbide segment for a honeycomb ceramic filter, and, more particularly, to a method for preparing a silicon carbide segment for a honeycomb ceramic filter having a very excellent filtering performance by subjecting an extruded body cut into a segment having a predetermined size, to perforation, plugging, and sintering processes, wherein a material (sealant), which will melt and adhere to the corners of cells in the sintering process, to seal the cell corners, is applied to partition walls at opposite ends of the segment in the plugging process, so that the plugging is completely achieved even at the cell corners, thereby preventing a miss plugging phenomenon causing leakage of particulate matter or dust due to incomplete plugging material filling, and thus minimizing the amount of gas discharged without being filtered.

### BACKGROUND OF THE INVENTION

Recently, serious environmental problems caused by atmospheric pollution, such as abnormal weather phenomena, have been raised. For this reason, the interest in diesel vehicles emitting a reduced amount of noxious gas such as carbon monoxide or hydrocarbon has been increased, as compared to gasoline vehicles, However, diesel vehicles have another problem in that they emit a large amount of nitrogen oxide (NOₓ) or particulate matter (PM) such as soot. To this end, research is being actively conducted for a diesel particulate filter (DPF) for removing noxious gas and PM emitted from diesel engines of vehicles.

A DPF is a device not only having a function for collecting PM contained in an exhaust gas emitted from a diesel vehicle, but also having a function for oxidizing the collected PM into carbon dioxide, water, etc. harmless to the human body in accordance with the reaction of a catalyst coated over the filter with the PM, using exhaust heat generated during the running of the vehicle, and thus regenerating the filter.

For such an exhaust fume filtering device, a honeycomb ceramic filter having a honeycomb structure is mainly used.

FIG. 1 is a schematic perspective view illustrating a silicon carbide segment for a general honeycomb ceramic filter. FIG. 2 is a schematic view illustrating a filtering procedure of the honeycomb ceramic filter of FIG. 1.

Referring to FIGS. 1 and 2, the honeycomb ceramic filter includes a ceramic segment 10 typically having a hexahedral shape with a square cross section. The ceramic segment 10 has a lattice structure including intersecting porous partition walls 11 defining a plurality of cells alternately communicating at opposite ends 20 and 30 of the ceramic segment 10. The cells are alternately plugged at the opposite ends 20 and 30 of the ceramic segment 10. Thus, the ceramic segment 10 includes closed cells 12 respectively closed by plugs, and open cells 13 not plugged by any plug. Therefore, the ceramic segment 10 exhibits checked cell patterns at the opposite ends 20 and 30 thereof.

An exhaust gas, which contains PM 40, is introduced into the open cells 13 open at the upstream end 20 of the ceramic segment 10, which has a porous structure. Thereafter, the exhaust gas passes through the porous partition walls 11 arranged adjacent to the open cells 13, and then emerges from the open cells 13 open at the downstream end 30 of the ceramic segment 10. In this case, the PM 40 contained in the exhaust gas, is collected in pores (not shown) formed in the partition walls 11 or at inner ends 15a of the plugs 15 fitted in the closed cells at the downstream end 30 of the ceramic segment 10. That is, the PM contained in the exhaust gas is filtered by the partition walls 11 while passing through the cells each having a cell structure open at the upstream end 20 in the form of the open cell 13, but closed at the downstream end 30 in the form of the closed cell 12.

When the collected PM is excessively accumulated in the porous ceramic filter, an increase in the pressure loss of the filter occurs, thereby causing a decrease in engine output. To this end, the PM collected in the porous ceramic filter is periodically burned, using an external burning means such as an electric heater or a burner, to regenerate the porous ceramic filter. In practical cases, two porous ceramic filters are assembled to constitute one filter set, in order to enable adoption of an alternate regeneration method, in which the two porous ceramic filters are alternately regenerated such that one porous ceramic filter is used while the other porous ceramic filter is regenerated.

In such a honeycomb ceramic filter, the plugs alternately fitted in the opposite ends of the honeycomb ceramic filter should be completely bonded to the associated partition walls, in order to prevent leakage of an exhaust gas introduced into the honeycomb ceramic filter, and thus to enable the PM contained in the exhaust gas to pass through the partition walls.

FIG. 3 schematically shows an enlarged view of one plug fitted in a silicon carbide segment manufactured in accordance with a conventional method.

Referring to FIG. 3, it can be seen that there is a gap between a plug 15 and each corner 16 of a cell defined by partition walls 11 to have a square cross-sectional shape as a plugging slurry (paste) is insufficiently filled in the cell at the corner 16 in a plugging process because the plugging slurry or paste exhibits a high cohesion. Such a gap formed between the plug 15 and each corner 16 of the cell causes many problems.

First, it is impossible to achieve effective filtering because the exhaust gas is introduced into the cell through the gap. As mentioned above, the exhaust gas is introduced into cells open at the upstream end of the filter, and is discharged out of the filter via cells arranged adjacent to the open cells while being open at the downstream end of the filter. The cells, which are open at the downstream end of the filter and allow the exhaust gas to be discharged therefrom, are connected to respective cells closed at the upstream end of the filter. For this reason, when the exhaust gas is introduced into the closed cells through gaps formed at the corners of the closed cells, it emerges from the open cells without being filtered by the porous partition walls.

Second, when the bonding force of the plugs to the partition walls is reduced, the plugs may be separated from the partition walls. Typically, impact and vibration are frequently externally applied to the honeycomb ceramic filter mounted to a vehicle, so that the same external force as the applied impact or vibration is applied to the silicon carbide segment constituting the honeycomb ceramic filter. For this reason, when the bonding force of the plugs to the partition walls is not large, the plugs may be separated due to the above-mentioned external force. In this case, the exhaust gas may be outwardly discharged without being filtered.

Up to the present, however, there is no technique for preventing a phenomenon in which a gap is formed between a plug and a partition wall corner.

A method for enhancing the bonding force between a plug and partition walls is disclosed in, for example, Korean Patent No. 368883. Conventionally, a plugging paste is upwardly inserted into a cell at the lower end of the cell. However, the plugging paste tends to be downwardly drawn by gravity in a direction, in which the plug is separated from the cell, so that a plug having a taper ring or bullet shape is formed. Due to such a shape, the bonding force of the plug to the partition walls of the cell is reduced. Korean Patent No. 368883 discloses a technique for upwardly moving a plugging paste, using gravity and vibration force, in order to solve a decrease in the bonding force of the plug to the partition walls of the cell. In spite of this technique, however, there is still a problem in that the paste cannot be sufficiently coated on the corners of the cell.

Japanese Laid-open Publication Nos. 2003-176709 and 2002-309922 disclose techniques for forming a protrusion at an outer surface of each plug arranged at an exhaust gas inlet end surface, to prevent a phenomenon that inlet flow channels are narrowed by particulates accumulated on the outer end surface of the plug. Of course, these techniques have no relation with the present invention. Although both the above-mentioned techniques propose formation of a protrusion, there is a limitation in practically using these techniques because the protrusion formation is practically difficult.

Therefore, there is a high demand for a technique capable of completely filling a plugging paste in desired cells around the corners of the cells, thereby preventing an exhaust gas from being introduced into or discharged from the closed cells while achieving a secure bonding of plugs to the partition walls of the cells, to achieve an enhanced filtering efficiency.

### SUMMARY OF THE INVENTION

Therefore, the present invention has been made to solve the above problems, and other technical problems that have yet to be resolved.

After active research and various repeated experiments, the inventors of the present invention found that, when a material (sealant), which will melt and adhere to the corners of cells in a sintering process, to seal the cell corners, is applied to partition walls at opposite ends of a segment in a plugging process, it is possible to prevent formation of a gap between each plug and the associated partition walls while achieving an enhancement in the bonding force between the plug and the associated partition walls, and thus to achieve a very excellent filtering efficiency.

### DESCRIPTION OF DRAWINGS

The above and other objects, features and other advantages of the present invention will be more clearly understood from the following detailed description taken in conjunction with the accompanying drawings, in which:

FIG. 1 is a perspective view of a silicon carbide segment for a general honeycomb ceramic filter;

FIG. 2 is a schematic view illustrating a filtering procedure conducted by the general honeycomb ceramic filter;

FIG. 3 is a perspective view of a silicon carbide segment prepared in accordance with a conventional method, including an enlarged view of one plug fitted in the silicon carbide segment;

FIGS. 4 and 5 are perspective views illustrating a plugging process for a silicon carbide segment according to an exemplary embodiment of the present invention for a honeycomb ceramic filter;

FIG. 6 is an enlarged sectional view of the silicon carbide segment according to the embodiment of the present invention for a honeycomb ceramic filter; and

FIGS. 7 to 12 are schematic views illustrating inlet and outlet-side cross-sections of exemplary segments, to which the present invention is applicable.

### DETAILED DESCRIPTION OF PREFERRED EMBODIMENTS

The present invention provides a method for preparing a silicon carbide segment for a honeycomb ceramic filter as a diesel particulate filter (DPF) by conducting drying, perforating, plugging, and sintering processes for an extruded body cut into a segment having a predetermined size, wherein a material (sealant), which will melt and adhere to corners of cells in the sintering process, to seal the cell corners, is applied to partition walls of the segment at opposite ends of the segment in the plugging process.

In accordance with this method, plugging is reliably achieved even at the corners of the cells. Accordingly, it is possible to enhance the bonding force between each plug and the associated partition walls while preventing a phenomenon that particulate matter or dust is leaked due to insufficient filling of the plugging material, namely, a miss plugging phenomenon, and thus to minimize the amount of gas discharged without being filtered. Thus, the present invention provides a method for preparing a silicon carbide segment exhibiting a very excellent filtering performance.

In a preferred embodiment, the method for preparing a silicon carbide segment for a honeycomb ceramic filter in accordance with the present invention comprises: (1) extruding, in the form of a honeycomb structure, a paste comprising SiC powder and fibers, an organic material as a binder, an oxide, water, etc.; (2) cutting the extruded body into a honeycomb segment having a predetermined size; (3) primarily drying the honeycomb segment by microwaves; (4) secondarily drying the honeycomb segment by hot air; (5) selectively plugging channels or cells of the honeycomb segment; and (6) sintering the honeycomb segment. In the plugging process (5), a sealant is applied to partition walls of the segment at opposite ends of the segment.

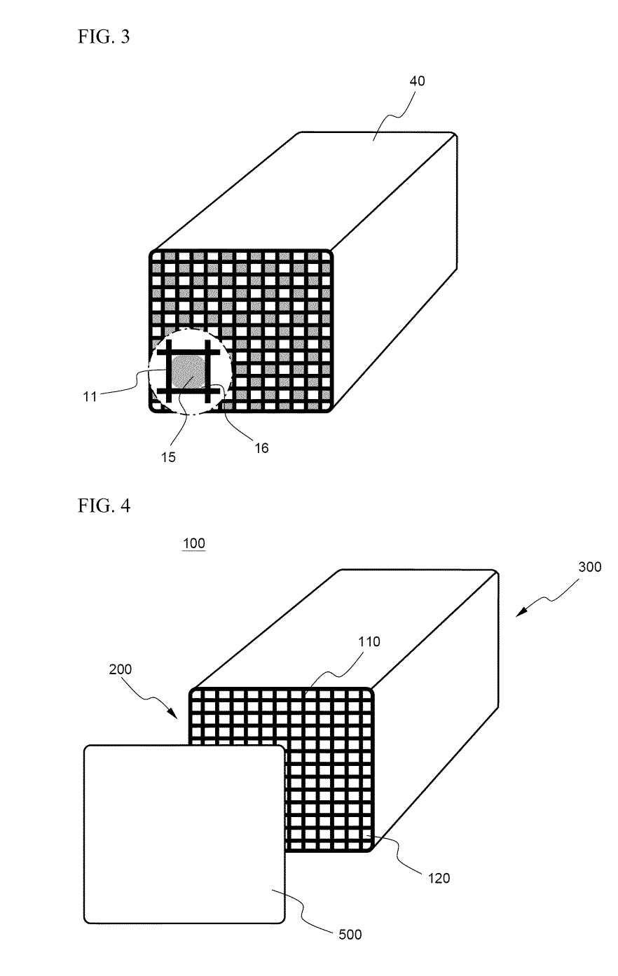

The sealant, which is applied to the partition walls of the segment at the opposite ends of the segment in the plugging process, subsequently melts and adheres to the corners of the cell partition walls in the sintering process. Accordingly, the region, in which the plugging paste is practically filled, corresponds to a cell space having a substantially square cross-section with round corners when the cross-section is taken in a direction perpendicular to an axial direction of each unit cell of the segment. Although the plugging paste cannot be completely filled in each cell at the corners of the cell defined by the partition walls, as mentioned above in conjunction with FIG. 3, the sealant fills gaps formed at the corners of each cell without being filled by the plugging paste.

There is no particular limitation on the sealant, as long as the sealant can melt and adhere to the partition walls in the sintering process, to seal the cell corners, but is not melted or degraded during the use of the ceramic filter. For example, the sealant may include glass frit, MgO, Al₂O₃, Fe₂O₃, TiO₂, MnO, ZnO, water glass, bentonite, boric acid, borax, CaCO₃, sodium nitrate, or feldspar. These materials may be used alone or in combination. Preferably, glass frit is used.

The plugging process does not mean only a process for inserting the plugging paste into the cells. The plugging process also includes pre-processes for the insertion of the plugging paste into the cells of the segment, namely, a perforating process, and a heating and/or sintering process for the plugging paste selectively inserted into the cells. Thus, the plugging process means the overall process for the selective formation of plugs in the segment. Meanwhile, the plugging process may be conducted for the honeycomb filter body not yet subjected to the heating and/or sintering process, or the honeycomb filter body subjected to the sintering process, namely, the sintered honeycomb filter body.

As described above, the application of the sealant is carried out in the plugging process. Accordingly, the application of the sealant may be carried out before and/or after the perforating process or the plugging paste inserting process.

In a preferred embodiment, a composition containing the sealant is coated over the opposite end surfaces of the segment in accordance with a rolling process. In this case, films are then attached to the opposite end surfaces of the segment, and a perforating process is conducted.

In this case, the sealant contained in the composition coated over the partition walls at the opposite ends of the segment melts in a sintering process, so that the melt moves to the corners of the cells as the surface tension is minimized. The melt is solidified as it is cooled at the ambient temperature. Thus, the sealant can be applied to the corners of the cells.

Preferably, the sealant-containing composition contains, in addition to the sealant, an organic binder, a solvent, etc. For the organic binder, polyvinyl alcohol, methylcellulose, ethylcellulose, or carboxylmethylcellulose may be used. Of course, the organic binder is not limited to these materials. The materials may be used alone or in combination. For the solvent, an organic solvent such as water or benzene, or alcohol such as methanol may be used. Of course, the solvent is not limited to these materials.

The perforating process is a pre-process for inserting the plugging paste to selected cells such that the cells at the opposite ends of the segment are alternately opened and closed. Although the perforating process may be conduced before the attachment of the films to the opposite end surfaces of the segment, it is preferred that the perforating process be conducted for selected cells after the attachment of the non-perforated films to the opposite end surfaces of the segment, in order to accurately perforate desired cells.

There is no particular limitation on the method of perforating the films. For example, a method for irradiating a laser beam onto desired portions of the films, or a method for piercing holes in the films, using a heated needle-shaped member, may be used.

For the films, a film, which can be melted by heat or a laser beam, may be used. Typically, a film having an adhesive layer is used so that it can be attached to the segment. That is, the film includes a substrate layer and an adhesive layer. The substrate layer may be made of a polymer such as polyester, polyolefin, or halogenated polyolefin. The adhesive layer may be made of an acryl-based adhesive. Of course, the substrate layer and adhesive layer are not limited to the above-described materials.

The film may contain a sealant. If necessary, a film, which includes an adhesive layer added with a sealant, may be used. Otherwise, a film, which includes a separate layer containing a sealant, may be used. A film, which includes a substrate layer added with a sealant as a filler, may also be used. Thus, the sealant can eventually be applied to the partition walls at the opposite ends of the segment as the films containing the sealant are attached to the opposite end surfaces of the segment before the perforating process.

Preferably, the films have a thickness of about 10 to 100 μm, taking into consideration the strength of the films and the ease of the perforating process.

Where the application of the sealant to desired regions is achieved by coating the sealant-containing composition or attaching the adhesive films, it is preferred that the sealant be applied at a thickness of 10 to 500 p.m. When the thickness of the sealant is excessively small, the amount of the sealant is insufficient to uniformly seal the cell corners. On the other hand, when the thickness of the sealant is excessively large, the amount of the sealant is excessively large, so that it may penetrate into the porous cells in a melted state, thereby causing a degradation in filtering performance.

The process of inserting the plugging paste is achieved by containing the plugging paste in a container, and then dipping the selectively-opened ends of the honeycomb ceramic filter, which has been subjected to the perforating process, into the plugging paste, which is in a slurry state, such that the plugging paste is filled in the selectively-opened cells. In this case, the plugging paste may be downwardly inserted into the honeycomb ceramic filter body from the top of the honeycomb ceramic filter body, or may be upwardly inserted into the honeycomb ceramic filter body from the bottom of the honeycomb ceramic filter body. A honeycomb ceramic filter suitable for a DPF can be prepared by conducting the plugging process for one end surface of the honeycomb ceramic filter body, and turning over the honeycomb ceramic filter body such that the plugged end surface is upwardly directed, and repeating the above-described process for the other end surface of the honeycomb ceramic filter body before the drying and sintering processes.

For the raw plug material contained in the plugging paste, the same material as the material useable for the honeycomb ceramic filter may be used. For example, the material may include at least one material selected from the group consisting of various ceramic such as cordierite, mullite, alumina, spinel, zirconia, silicon carbide, a silicon carbide-cordierite-based composite material, a silicon-silicon carbide-based composite material, silicon nitride, lithium aluminum silicate, aluminum titanate, and zeolite, metals such as Fe—Cr—Al-based metal, and combinations thereof. The material may be used in the form of powder, fiber, or a mixture thereof, but is not limited thereto.

In order to bond the plugging paste to the cell partition walls after the plugging paste insertion process, the honeycomb ceramic filter body is dried, together with the plugs, to remove water from the plugging paste. Thereafter, the dried honeycomb ceramic filter body is sintered at an appropriate temperature. The sintering temperature is varied in accordance with the plugging material used. For example, in the case of standard cordierite plugs, they may be sintered at a temperature of about 1,400° C. For other kinds of plugs, the sintering temperature may be lowered to a range of 900 to 1,300° C.

The present invention provides a silicon carbide segment for a honeycomb ceramic filter prepared by the above-described method.

The silicon carbide segment for a honeycomb ceramic filter, in which a sealant is applied to the corners of closed cells in accordance with the present invention, is a novel structure by itself That is, the present invention is not limited to the preparation method for the silicon carbide segment. Thus, the present invention provides a silicon carbide segment for a honeycomb ceramic filter comprising a lattice structure including partition walls intersecting to define a plurality of cells alternately communicating at opposite ends of the segment, wherein the cells are alternately plugged at the opposite ends of the segment such that the cells comprise closed cells respectively closed by plugs, and open cells not plugged by any plug, and a sealant is applied to corners of the closed cells.

In the silicon carbide segment for a honeycomb ceramic filter, the sealant seals gaps formed at the corners of the cells, and enhances the bonding force between the plugs of the closed cells and the partition walls. Accordingly, it is possible to effectively solve many problems incurred due to the gaps formed at the corners of the cells, for example, introduction of an exhaust gas, a degradation in filtering efficiency, and separation of plugs caused by external impact due to insufficient bonding force. Thus, excellent filtering efficiency can be obtained.

There is no particular limitation on the intersection type and lattice shape of the barrier walls. Accordingly, the cells defined in accordance with the intersection of the partition walls may have various cross-sections. For example, the cells may have various cross-sectional shapes including a triangular shape, a square shape, a polygonal shape such as an octagonal shape, and combinations thereof.

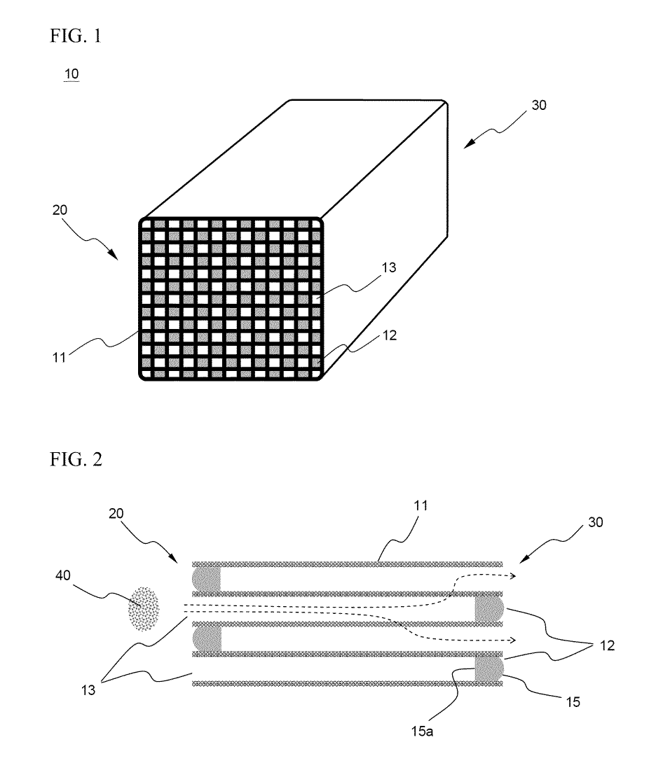

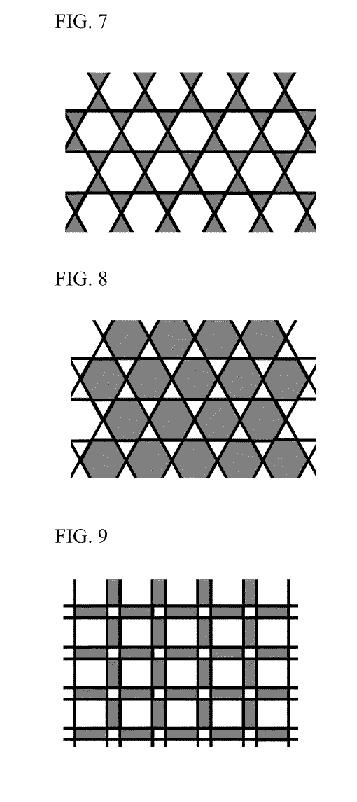

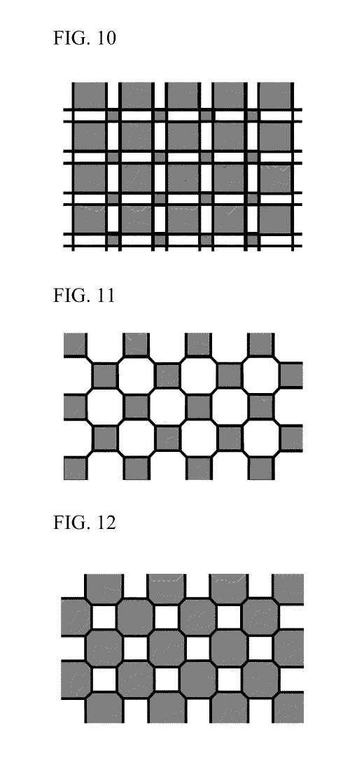

The intersection type of the partition walls and the cross-sectional shape of the cells may be determined to form a structure having a checked pattern (FIG. 1), a structure including cells having a hexagonal cross-section, and cells formed at respective sides of the hexagonal cells while having a triangular cross-section (a hex-tri cell structure shown in FIGS. 7 and 8), a structure, in which partition walls are arranged with two different pitches, to form large square cells, small square cells, and rectangular cells arranged at respective sides of the large or small square cells (a double-pitch cell structure shown in FIGS. 9 and 10), or a structure including cells each having an octagonal cross-section while being connected to one another at each diagonal side, and square cells arranged at respective upper, lower, left, and right sides of the octagonal cells (an octo-square cell structure shown in FIGS. 11 and 12). Of course, the intersection type of the partition walls and the cross-sectional shape of the cells are not limited to the above-described structures. A preferred cell structure is the octo-square cell structure, which is a combination of octagonal cells and square cells.

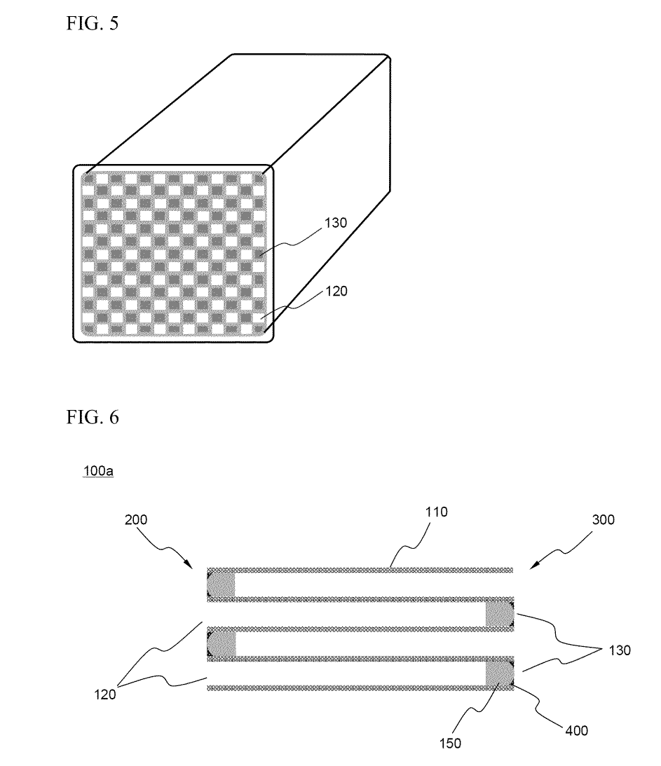

In order to enable the segment to perform a filtering operation, the cells of the segment, which are opened at the inlet-side end of the segment, through which an exhaust gas is introduced, are closed at the outlet-side end of the segment, through which the exhaust gas is discharged. On the other hand, the cells of the segment, which are closed at the inlet-side end of the segment, are opened at the outlet-side end of the segment.

Where the open cells and closed cells are alternately arranged, it is preferred that the area of each open cell at the inlet-side end of the segment be relatively large, and the area of each closed cell at the outlet-side end of the segment be relatively large. For example, in the case of a segment having a cell arrangement shown in FIGS. 5 and 6, the inlet-side end of the segment may have an arrangement of FIG. 7, 9, or 11, and the outlet-side end of the segment may have an arrangement of FIG. 8, 10, or 12 corresponding to the arrangement of FIG. 7, 9, or 11, such that the segment has a relatively-large open cell area at the inlet-side end.

The silicon carbide segment itself may have various shapes. In a preferred embodiment, the silicon carbide segment may have a rectangular parallelepiped shape having a square cross-section. The number of silicon carbide segments bonded together to form a honeycomb ceramic filter, in which catalyst ingredients are carried, is appropriately determined in accordance with a desired size of the honeycomb ceramic filter.

The present invention also provides a honeycomb ceramic filter prepared by bonding a plurality of silicon carbide segments as described above.

The structure of the honeycomb ceramic filter and the segment bonding method are well known, so no detailed description thereof will be given.

Hereinafter, the present invention will be further described in conjunction with embodiments illustrated in the accompanying drawings, but is not limited thereto.

FIGS. 4 and 5 schematically illustrate a plugging process for a silicon carbide segment for a honeycomb ceramic filter according to the present invention.

Referring to these drawings, a silicon carbide segment body 100, which is prepared by a certain extrusion process, has a lattice structure including partition walls 110 intersecting to define a plurality of open cells 120 communicating together at opposite ends 200 and 300 of the ceramic segment 100.

A sealant-containing composition (not shown) is coated over the surface of one end of the segment body 100, namely, the end 200, using a rolling method or the like. A film 500 is then attached to the end 200 of the segment body 100. The film 500 may contain a sealant. In this case, the sealant-containing film 500 is attached to the end 200 of the segment body 100 without the coating of the sealant-containing composition.

Thereafter, a perforating process is conducted by irradiating a laser beam onto portions of the film 500 corresponding to selected cells. The silicon carbide segment body 100 is then dipped into a bath (not shown) containing a plugging paste, to insert the plugging paste into the selected cells. Subsequently, the silicon carbide segment body 100 is dried.

The above-described procedure is repeated for the other end of the silicon carbide segment body 100, namely, the end 300.

As a result, the cells are selectively plugged in an alternating manner. Thus, the silicon carbide segment body 100 includes closed cells 130 closed by the plugs, and open cells 120 not plugged by any plug.

Finally, a sintering process is conducted. In the sintering process, organic ingredients are decomposed, so that they are removed. On the other hand, inorganic ingredients are coupled together. Thus, the sealant is melted, and fused to the cell corners. Accordingly, the sealant effectively closes the cell corners, on which it is difficult to coat the plugging paste.

FIG. 6 schematically shows the cross-section of the silicon carbide segment according to the present invention for a honeycomb ceramic filter.

As shown in FIG. 6, in the silicon carbide segment 100a for a honeycomb ceramic filter according to the present invention, there is no gap between each plug 150 and the associated partition walls 110 because the corners of each closed cell 130 are completely closed by the sealant 400. Accordingly, an exhaust gas containing particulate matter (PM) is introduced into only the open cells 120, which are opened at the upstream end 200 of the silicon carbide segment 100a, and is then discharged from each open cell 120, which is opened at the downstream end 300 of the silicon carbide segment 100a after passing through the porous partition walls 100 arranged adjacent to the open cell 120.

Accordingly, it is possible to prevent noxious particulate matter contained in the exhaust gas from being discharged to the atmosphere without being filtered out due to the existence of fine gaps formed between the plugs and the partition walls or the non-existence of plugs. Thus, it is possible to achieve a great enhancement in filtering efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As apparent from the above description, in the method for preparing a silicon carbide segment for a honeycomb ceramic filter in accordance with the present invention, a material (sealant), which will melt and adhere to the corners of cells in a sintering process, to seal the cell corners, is applied to partition walls at opposite ends of the segment in a plugging process, so that it is possible to prevent noxious particulate matter contained in an exhaust gas from being discharged to the atmosphere without being filtered out due to the existence of fine gaps formed between the plugs and the partition walls or the non-existence of plugs. It is also possible to enhance the bonding force of the plugs to the cell partition walls, and thus to prevent the plugs from being separated due to an external force such as impact or vibration.

1. A method for preparing a silicon carbide segment for a honeycomb ceramic filter as a diesel particulate filter (DPF) by conducting drying, perforating, plugging, and sintering processes for an extruded body cut into a segment having a predetermined size, wherein a sealant, which will melt and adhere to corners of cells in the sintering process, to seal cell corners, is applied to partition walls of the segment at opposite ends of the segment in the plugging process.

2. The method according to claim 1, wherein the sealant comprises one or more selected from the group consisting of glass frit, MgO, Al₂O₃, Fe₂O₃, TiO₂, MnO, ZnO, water glass, bentonite, boric acid, borax, CaCO₃, sodium nitrate, and feldspar.

3. The method according to claim 2, wherein the sealant comprises glass frit.

4. The method according to claim 1, wherein the perforating process is conducted after coating a coating composition containing the sealant over surfaces of the opposite ends of the segment by a rolling method, and attaching films to respective end surfaces of the segment, to perforate the films.

5. The method according to claim 4, wherein the coating composition comprises the sealant, an organic binder, and a solvent.

6. The method according to claim 1, wherein the perforating process is conducted after attaching films containing the sealant to respective surfaces of the opposite ends of the segment, to perforate the films.

7. The method according to claim 6, wherein each of the films comprises a film having an adhesive layer containing the sealant, a film having an adhesive layer and a separate layer containing the sealant, or a film having a film substrate containing the sealant as a filler.

8. The method according to claim 1, wherein the sealant has a thickness of 10 to 500 μm.

9. A silicon carbide segment for a honeycomb ceramic filter prepared by the method according to claim 1.

10. A silicon carbide segment for a honeycomb ceramic filter comprising:
a lattice structure including partition walls intersecting to define a plurality of cells alternately communicating at opposite ends of the silicon carbide segment,
wherein the cells being alternately plugged at the opposite ends of the silicon carbide segment such that the cells comprise closed cells respectively closed by plugs, and open cells not plugged by any plug, and a sealant is applied to corners of the closed cells.

11. A honeycomb ceramic filter comprising:
a plurality of silicon carbide segments according to claim 9, the silicon carbide segments being bonded together.

12. A honeycomb ceramic filter comprising:
a plurality of silicon carbide segments according to claim 10, the silicon carbide segments being bonded together.

13. A silicon carbide segment for a honeycomb ceramic filter prepared by the method according to claim 2.

14. A silicon carbide segment for a honeycomb ceramic filter prepared by the method according to claim 3.

15. A silicon carbide segment for a honeycomb ceramic filter prepared by the method according to claim 4.

16. A silicon carbide segment for a honeycomb ceramic filter prepared by the method according to claim 5.

17. A silicon carbide segment for a honeycomb ceramic filter prepared by the method according to claim 6.

18. A silicon carbide segment for a honeycomb ceramic filter prepared by the method according to claim 7.

19. A silicon carbide segment for a honeycomb ceramic filter prepared by the method according to claim 8.
